(19) United States
(12) Patent Application Publication
(10) Pub. No.: US 2025/0245962 A1
(43) Pub. Date: Jul. 31, 2025

(54) ADAPTIVE INTERPUPILLARY DISTANCE ESTIMATION FOR VIDEO SEE-THROUGH (VST) EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 18/986,088

(22) Filed: Dec. 18, 2024

Related U.S. Application Data
(60) Provisional application No. 63/625,695, filed on Jan. 26, 2024.

(51) Int. Cl. G06V 10/74; G06T 3/40; G06V 40/16

(52) U.S. Cl. CPC G06V 10/761; G06T 3/40; G06V 40/161; G06V 40/171; G06V 2201/07

(57) ABSTRACT

A method includes obtaining one or more images capturing a face of a user and a reference object with one or more known dimensions. The method also includes identifying a first plane on which eyes of the user are located and a second plane on which the reference object is located and projecting image data of the reference object from the second plane onto the first plane. The method further includes determining a sizing factor based on pixels that the reference object occupies after being projected onto the first plane and the known dimension(s). The method also includes identifying a number of pixels between centers of pupils of the user's eyes in the image(s). In addition, the method includes identifying an estimate of an interpupillary distance of the user's eyes by applying the sizing factor to the number of pixels between the centers of the pupils of the user's eyes.

### CROSS-REFERENCE TO RELATED APPLICATION AND PRIORITY CLAIM

This application claims priority under 35 U.S.C. § 119(e) to U.S. Provisional Patent Application No. 63/625,695 filed on Jan. 26, 2024. This provisional patent application is hereby incorporated by reference in its entirety.

### TECHNICAL FIELD

This disclosure relates generally to extended reality (XR) systems and processes or other systems and processes involving users. More specifically, this disclosure relates to adaptive interpupillary distance estimation for video see-through (VST) XR or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to adaptive interpupillary distance estimation for video see-through (VST) extended reality (XR) or other applications.

In a first embodiment, a method includes obtaining, using at least one processing device of an electronic device, one or more images capturing a face of a user and a reference object with one or more known dimensions. The method also includes identifying, using the at least one processing device, a first plane on which eyes of the user are located and a second plane on which the reference object is located. The method further includes projecting, using the at least one processing device, image data of the reference object from the second plane onto the first plane. The method also includes determining, using the at least one processing device, a sizing factor based on (i) pixels that the reference object occupies after being projected onto the first plane and (ii) the one or more known dimensions. The method further includes identifying, using the at least one processing device, a number of pixels between centers of pupils of the user's eyes in the one or more images. In addition, the method includes identifying, using the at least one processing device, a first estimate of an interpupillary distance of the user's eyes by applying the sizing factor to the number of pixels between the centers of the pupils of the user's eyes.

In a second embodiment, an electronic device includes at least one processing device configured to obtain one or more images capturing a face of a user and a reference object with one or more known dimensions. The at least one processing device is also configured to identify a first plane on which eyes of the user are located and a second plane on which the reference object is located. The at least one processing device is further configured to project image data of the reference object from the second plane onto the first plane. The at least one processing device is also configured to determine a sizing factor based on (i) pixels that the reference object occupies after being projected onto the first plane and (ii) the one or more known dimensions. The at least one processing device is further configured to identify a number of pixels between centers of pupils of the user's eyes in the one or more images. In addition, the at least one processing device is configured to identify a first estimate of an interpupillary distance of the user's eyes by applying the sizing factor to the number of pixels between the centers of the pupils of the user's eyes.

In a third embodiment, a non-transitory machine readable medium contains instructions that when executed cause at least one processor of an electronic device to obtain one or more images capturing a face of a user and a reference object with one or more known dimensions. The non-transitory machine readable medium also contains instructions that when executed cause the at least one processor to identify a first plane on which eyes of the user are located and a second plane on which the reference object is located. The non-transitory machine readable medium further contains instructions that when executed cause the at least one processor to project image data of the reference object from the second plane onto the first plane. The non-transitory machine readable medium also contains instructions that when executed cause the at least one processor to determine a sizing factor based on (i) pixels that the reference object occupies after being projected onto the first plane and (ii) the one or more known dimensions. The non-transitory machine readable medium further contains instructions that when executed cause the at least one processor to identify a number of pixels between centers of pupils of the user's eyes in the one or more images. In addition, the non-transitory machine readable medium contains instructions that when executed cause the at least one processor to identify a first estimate of an interpupillary distance of the user's eyes by applying the sizing factor to the number of pixels between the centers of the pupils of the user's eyes.

Any one or any combination of the following features may be used with the first, second, or third embodiment. The number of pixels between the centers of the pupils of the user's eyes may be determined by using a face detection model to identify an area in each of the one or more images containing the user's face and using a facial landmark extraction model to identify the centers of the pupils of the user's eyes in each area containing the user's face. The first estimate of the interpupillary distance of the user's eyes may be verified by identifying distances between at least one imaging sensor used to capture the one or more images and the centers of the pupils of the user's eyes based on depth data associated with the one or more images; identifying locations of the centers of the pupils of the user's eyes in a three-dimensional (3D) space based on (i) the distances between the at least one imaging sensor and the centers of the pupils of the user's eyes, (ii) a focal length of each imaging sensor, and (iii) locations of the centers of the pupils of the user's eyes in the one or more images; identifying a second estimate of the interpupillary distance of the user's eyes based on a difference in the locations of the centers of the pupils of the user's eyes in the 3D space; and comparing the second estimate of the interpupillary distance of the user's eyes to the first estimate of the interpupillary distance of the user's eyes. The one or more images may include a stereo pair of images, and the first estimate of the interpupillary distance of the user's eyes may be verified by rectifying the stereo pair of images to generate a rectified stereo pair of images; identifying distances between at least one imaging sensor used to capture the stereo pair of images and the centers of the pupils of the user's eyes based on the rectified stereo pair of images; and verifying the first estimate of the interpupillary distance of the user's eyes based on the distances between the at least one imaging sensor and the centers of the pupils of the user's eyes. The first and second planes may be identified using a trained machine learning model. The electronic device may include a portable computing device, and the first estimate of the interpupillary distance of the user's eyes may be transmitted to an XR headset configured to be worn by the user. The reference object may include any object having a known size, and the reference object may be positioned at any location within the one or more images where the reference object is fully visible.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for adaptive interpupillary distance estimation in accordance with this disclosure;

FIGS. 3A through 3C illustrate example functions in the process of FIG. 2 in accordance with this disclosure;

FIGS. 4A and 4B illustrate an example architecture supporting adaptive interpupillary distance estimation in accordance with this disclosure;

FIG. 5 illustrates an example process for planar reprojection associated with a reference object during adaptive interpupillary distance estimation in accordance with this disclosure;

FIG. 6 illustrates an example process for identification of pixels during adaptive interpupillary distance estimation in accordance with this disclosure;

FIG. 7 illustrates an example process for verification of an interpupillary distance estimation during adaptive interpupillary distance estimation in accordance with this disclosure;

FIG. 8 illustrates an example process for rectification of a stereo pair of images during adaptive interpupillary distance estimation in accordance with this disclosure; and

FIG. 9 illustrates an example method for adaptive interpupillary distance estimation in accordance with this disclosure.

### DETAILED DESCRIPTION

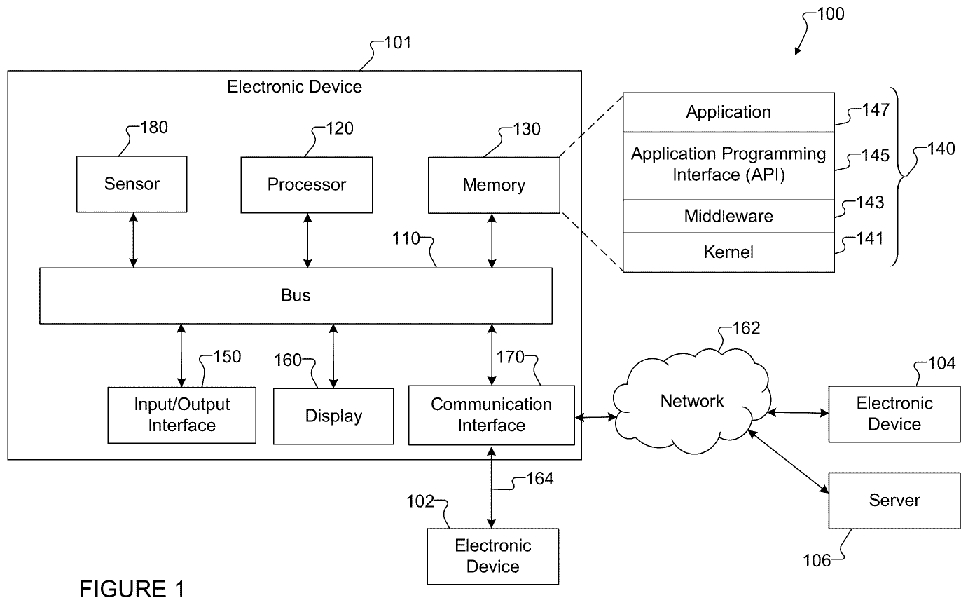

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes. One type of XR system is a video see-through (VST) XR system (also called a “passthrough” XR system), which present a user with a generated video sequence of a real-world scene. VST XR systems can be built using virtual reality (VR) technologies and can have various advantages over OST XR systems. For instance, VST XR systems can provide wider fields of view and can provide improved contextual augmented reality.

Interpupillary distance (IPD) can be useful or important in designing and using XR devices and in a number of other applications. Interpupillary distance refers to the distance between the centers of the pupils of a person's eyes. Often times, each individual user's interpupillary distance needs to be known so that an XR device can be adjusted for use by that individual user. Among other things, this may allow each user to see correct final views generated by that user's XR device. One common way of measuring interpupillary distance is through the use of a device called an Essilor pupilometer. However, most people do not have easy access to a pupilometer, and requiring each user of an XR device to have access to a pupilometer can interfere with that user's usage of his or her XR device.

This disclosure provides various techniques supporting adaptive interpupillary distance estimation for VST XR or other applications. As described in more detail below, one or more images capturing a face of a user and a reference object with one or more known dimensions can be obtained. A first plane on which eyes of the user are located and a second plane on which the reference object is located can be identified, and the reference object can be projected from the second plane onto the first plane. A sizing factor can be determined based on (i) pixels that the reference object occupies after being projected onto the first plane and (ii) the one or more known dimensions, and a number of pixels between centers of pupils of the user's eyes in the one or more images can be identified. An estimate of an interpupillary distance of the user's eyes can be identified by applying the sizing factor to the number of pixels between the centers of the pupils of the user's eyes. In some cases, an electronic device may identify the estimate of an interpupillary distance of the user's eyes and may transmit the estimate of the interpupillary distance of the user's eyes to an XR headset configured to be worn by the user.

In this way, the disclosed techniques provide an efficient mechanism to determine the interpupillary distance of each user. This may allow, for example, more efficient configuration of XR headsets or other devices worn by the users. As a particular example, a pipeline used in an XR device can be designed to implement changes to rendered images based on the interpupillary distance of the user currently using the XR device, such as by creating mappings and transformations of final view image frames. Moreover, the users are not required to have access to a pupilometer or other specialized device. Instead, the described techniques can be performed using electronic devices that are typically available to users, such as smartphones, tablet computers, or laptop computers. This may allow the users' interpupillary distances to be identified more easily and quickly. In addition, the described techniques may allow for the use of any reference object having a known size, and the reference object may be positioned at any location within one or more images where the reference object is fully visible (as opposed to using a specific type of reference object at a specific position within an image). Overall, these techniques can significantly increase the accuracy and decrease the difficulty of generating interpupillary distance estimates.

Note that interpupillary distance estimates may be used in any suitable manner. In the following discussion, it is often assumed that interpupillary distance estimates of users are generated by or provided to XR devices worn by the users, where the interpupillary distance estimates can be used to adjust how the XR devices generate rendered images for presentation to the users. However, interpupillary distance estimates may be used in other ways and in other applications or use cases, such as to identify or configure eyeglasses to be worn by users or to adjust other optical devices. In general, this disclosure is not limited to any specific use of interpupillary distance estimates.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to adaptive interpupillary distance estimation for VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform adaptive interpupillary distance estimation for VST XR or other applications, possibly along with one or more functions related to or based on interpupillary distance estimates. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to adaptive interpupillary distance estimation for VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

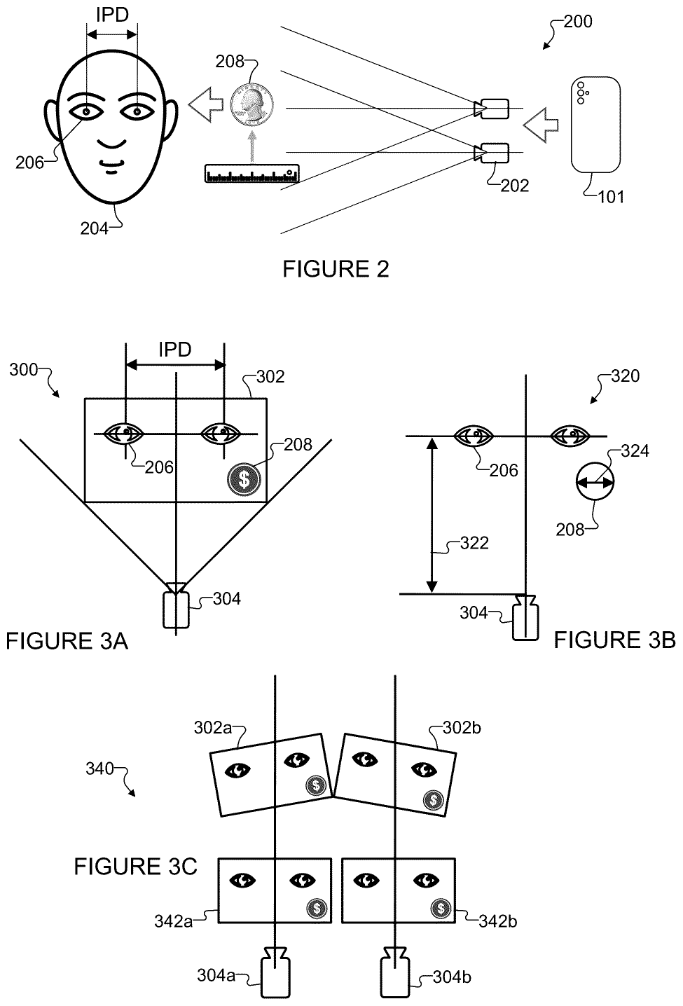

FIG. 2 illustrates an example process 200 for adaptive interpupillary distance estimation in accordance with this disclosure. For case of explanation, the process 200 shown in FIG. 2 is described as being performed using or as involving the use of the electronic device 101 in the network configuration 100 shown in FIG. 1. However, the process 200 may be performed using any other suitable device(s) and in any other suitable system(s).

As shown in FIG. 2, the electronic device 101 takes the form of a smartphone in this example. However, the electronic device 101 may have any other suitable form, such as a portable computing device (like a tablet computer, a laptop computer, or a smartwatch) or a fixed computing device (like a desktop computer). The electronic device 101 includes or is used in conjunction with one or more cameras 202. In some cases, the one or more cameras 202 may represent one or more imaging sensors 180 of the electronic device 101. Any suitable number of cameras 202 may be used here. In some embodiments, a single camera 202 is used. In other embodiments, multiple cameras 202, such as a stereo pair of cameras 202, are used.

The one or more cameras 202 can be used to capture images of scenes. In this example, the one or more cameras 202 can be used to capture one or more images of a person 204 and at least one reference object 208. The person 204 represents someone for whom the person's interpupillary distance (IPD) is to be measured, where the person's interpupillary distance represents the distance between the centers of the pupils of the person's eyes 206. In some embodiments, the electronic device 101 can process one or more images of the person 204 and the reference object(s) 208 in order to estimate the person's interpupillary distance. In other embodiments, the electronic device 101 can provide one or more images of the person 204 and the reference object(s) 208 to another device (such as the server 106) for use in estimating the person's interpupillary distance.

Note that any suitable number of images may be captured and used to estimate the person's interpupillary distance, such as a single image or multiple images (like a stereo pair of images). Also note that the person's interpupillary distance may be estimated multiple times (such as based on different images or stereo pairs of images), and the results can be averaged or otherwise processed to estimate the person's interpupillary distance.

Each reference object 208 that is captured in one or more images here can represent any suitable object having one or more known dimensions. In this example, the reference object 208 represents a coin, namely a quarter in this particular example (although other types of coins may be used). In other cases, the reference object 208 may represent a bank card, credit card, ruler, or other object having a known height, width, diameter, or other dimension(s).

Note that the dimension(s) of each reference object 208 may be identified in any suitable manner. For example, the electronic device 101 or another device may have access to known dimensions of known types of objects, have the ability to access the Internet or database to retrieve known dimensions of known types of objects, or receive dimensions from a user (such as a user of the electronic device 101). Also note that each reference object 208 may have any suitable position relative to the person's face while one or more images are captured by the camera(s) 202. For instance, a reference object 208 may be above, below, to the left, to the right, or diagonal relative to the person's face. A reference object 208 may also or alternatively overlap at least a portion of the person's face.

As described below, part of the processing that can be performed using the image(s) of the person 204 and the reference object(s) 208 can include identifying a first plane on which the person's eyes 206 are located and a second plane on which a reference object 208 is located. The reference object 208 can be projected from its corresponding second plane onto the first plane, and a sizing factor (also called a scaling factor) can be determined based on (i) pixels that the reference object 208 occupies after being projected onto the first plane and (ii) the one or more known dimensions of the reference object 208. For instance, the one or more known dimensions of the reference object 208 can be used to identify a distance associated with each pixel occupied by the reference object 208 after being projected onto the first plane. A number of pixels between centers of pupils of the person's eyes 206 can be identified, and an estimate of the person's interpupillary distance can be determined by applying the sizing factor to the number of pixels between the centers of the pupils of the person's eyes 206 (such as by multiplying the number of pixels between the centers of the pupils of the person's eyes 206 by the sizing factor).

Once the interpupillary distance for the person 204 is estimated, the interpupillary distance estimate may be used in any suitable manner. For example, the interpupillary distance estimate may be displayed by the electronic device 101 or otherwise provided to the person 204 for use, such as when the person 204 can input the interpupillary distance estimate into an XR headset or use the interpupillary distance estimate when ordering eyeglasses. As another example, the interpupillary distance estimate may be provided from the electronic device 101 to another device, such as an XR headset, for use. As still another example, the interpupillary distance estimate may be generated and used by the electronic device 101, such as when the electronic device 101 represents an XR headset. As a particular example, an XR headset may use the interpupillary distance estimate in order to control how rendered images are generated for presentation to the person 204. Among other things, this may allow for simpler configuration of the XR headset for use by the person 204 or for simpler reconfiguration of the XR headset for use by different people at different times.

Although FIG. 2 illustrates one example of a process 200 for adaptive interpupillary distance estimation, various changes may be made to FIG. 2. For example, any suitable number of cameras 202 may be used here. Also, any suitable reference object(s) 208 may be used here. In addition, the electronic device 101 may be used to capture one or more images of the person 204 and the reference object(s) 208, but another device (such as the server 106) may process the image(s) and identify the person's interpupillary distance estimation.

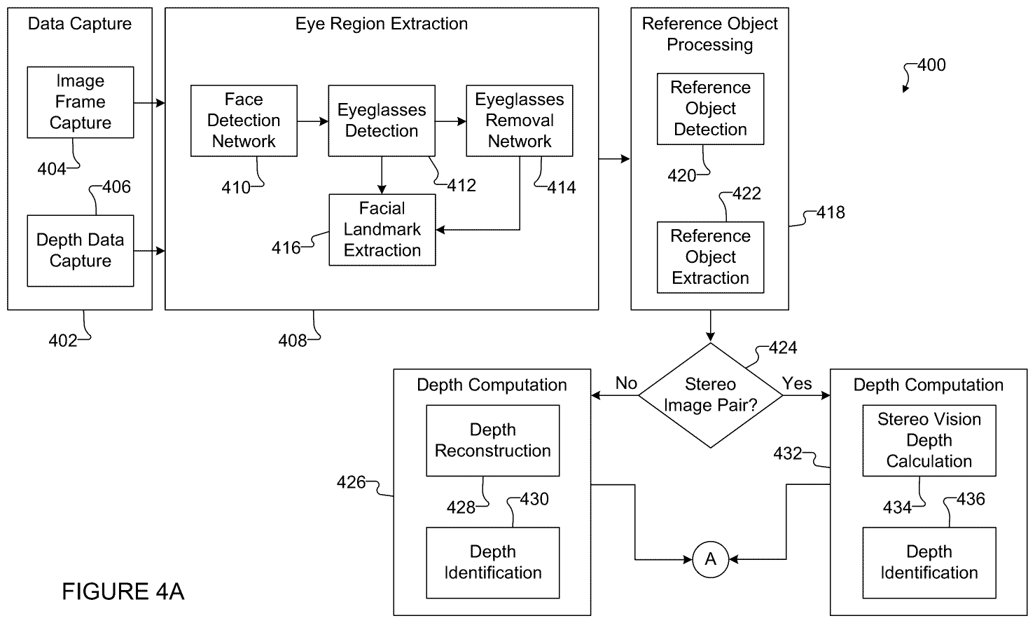

FIGS. 3A through 3C illustrate example functions in the process 200 shown in FIG. 2 in accordance with this disclosure. As shown in FIG. 3A, one operation associated with the process 200 is an interpupillary distance estimation operation 300. During the operation 300, the electronic device 101 or another device can obtain at least one image 302 capturing a person's eyes 206 and at least one reference object 208. Using suitable processing, the electronic device 101 or another device can identify a first plane on which the person's eyes 206 are located, identify a second plane on which each reference object 208 is located, and project each reference object 208 onto the first plane. The electronic device 101 or another device can also use the known dimension(s) of each reference object 208 to estimate the distance represented by each pixel of the image 302. By counting the number of pixels in the image 302 between the centers of the pupils of the person's eyes 206, an estimate of the person's interpupillary distance can be generated.

As noted earlier, there is no requirement here that the reference object 208 appear at any specific location within the image 302. As long as the person's eyes 206 are visible and an estimated number of pixels between the centers of the pupils of the person's eyes 206 can be determined, the reference object 208 may have any suitable position within the image 302. Note that a camera 304 shown here may represent an actual camera used to capture the image 302 or a virtual camera. The virtual camera can represent a virtual location at which the image 302 is generated using one or more other images, such as when multiple images from multiple cameras 202 are combined to produce an image 302 that appears to have been taken from the position of the virtual camera.

As shown in FIG. 3B, another operation that may be associated with the process 200 is an interpupillary distance refinement operation 320. During the operation 320, the electronic device 101 or another device can verify or refine a person's interpupillary distance estimate (such as one generated using the interpupillary distance estimation operation 300). For example, the electronic device 101 or another device can identify an estimate of a depth 322 between an actual or virtual camera 304 and the person's eyes 206. Based on an estimate of the depth 322 (and optionally knowledge of one or more dimensions 324 of the at least one reference object 208), it is possible for the electronic device 101 or another device to verify an interpupillary distance estimate and increase or decrease the interpupillary distance estimate if necessary. This can be done, for instance, by performing triangulation using the depth 322 and the positions of the centers of the pupils of the person's eyes 206.

The depth 322 can be estimated in any suitable manner, such as by estimating depths using a single image or by estimating depths using a stereo pair of images. As a particular example, depths within a single image may be estimated using a trained machine learning model or other logic. Estimating depths using a stereo pair of images may be based on disparities within the stereo pair of images, meaning the same points within a scene can appear at different locations within different images. The differences (disparities) between the different locations are related to the depths of those points within the scene, so the disparities can be used to estimate depths within the scene. In other cases, the electronic device 101 may include one or more depth sensors 180, which could be used to capture sparse depths or other depths within each scene imaged using the imaging sensor(s) 180. In general, this disclosure is not limited to any particular technique for estimating depths.

As shown in FIG. 3C, still another operation that may be associated with the process 200 is an image rectification operation 340. In some cases, multiple cameras 304a-304b may be used to capture multiple images 302a-302b of a person 204 and at least one reference object 208. Among other things, due to the different locations of the different cameras during image capture, scene contents like the person's eyes 206 and the reference object 208 can appear at different locations in different captured images 302a-302b. Note that these differences are exaggerated for ease of illustration in FIG. 3C.

During the operation 340, warping or other projections can be applied to the captured images 302a-302b in order to convert the captured images 302a-302b into converted images 342a-342b. The projections here are effectively transformations of the captured images 302a-302b to a common image plane. The converted images 342a-342b can also be rectified so that common points appear at common locations within the rectified images. Any suitable techniques can be used to perform the transformation and rectification (also called alignment) functions. Once rectified, the rectified images can be used (such as during the interpupillary distance estimation operation 300) to generate an interpupillary distance estimation. Note that the image rectification operation 340 might only be performed when there are multiple captured images 302a-302b of the person 204 and the reference object(s) 208.

Although FIGS. 3A through 3C illustrate examples of functions in the process 200 shown in FIG. 2, various changes may be made to FIGS. 3A through 3C. For example, the interpupillary distance refinement operation 320 may or may not be needed or performed. Also, the image rectification operation 340 may or may not be needed or performed, such as when the image rectification operation 340 is not performed if single images are captured and processed.

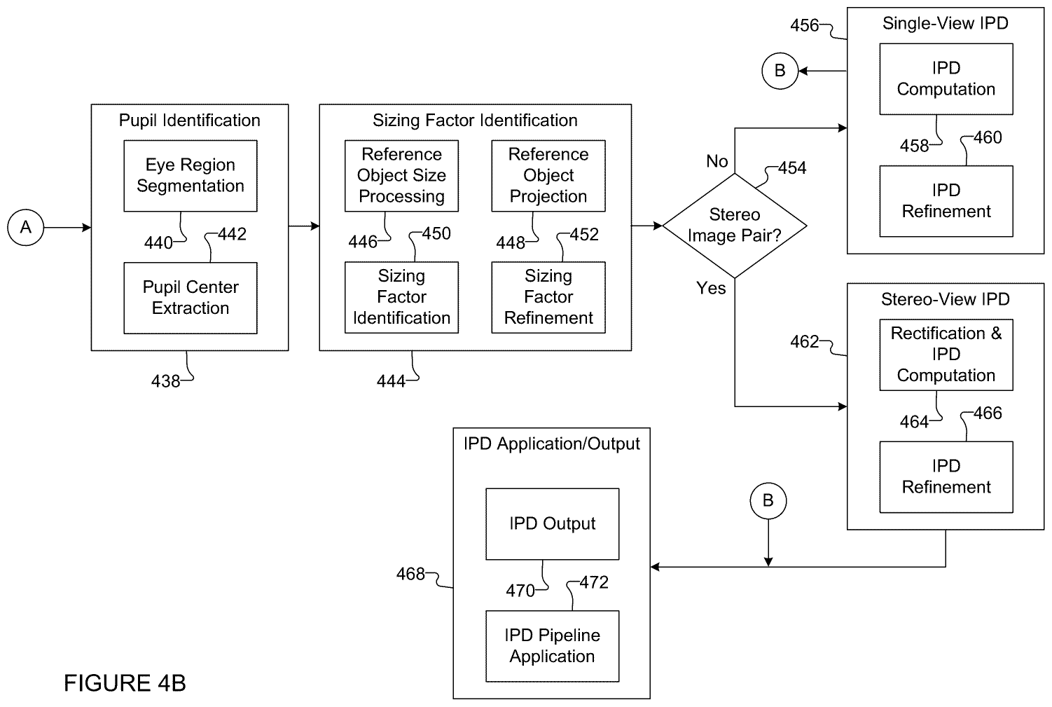

FIGS. 4A and 4B illustrate an example architecture 400 supporting adaptive interpupillary distance estimation in accordance with this disclosure. For ease of explanation, the architecture 400 shown in FIGS. 4A and 4B is described as being implemented using the electronic device 101 in the network configuration 100 shown in FIG. 1, such as to implement the process 200 shown in FIG. 2. However, the architecture 400 may be implemented using any other suitable device(s) and in any other suitable system(s), and the architecture 400 may be used to implement any other suitable process(es) designed in accordance with this disclosure.

As shown in FIG. 4A, a data capture operation 402 generally operates to obtain image frames and optionally depth data associated with the image frames. For example, the data capture operation 402 may include an image frame capture function 404, which can be used to obtain one or more images to be processed using the architecture 400. The one or more images may be obtained from any suitable source, such as from one or more imaging sensors 180 of the electronic device 101. As described above, each image can capture a person's eyes 206 and at least one reference object 208. The number of obtained images can vary depending on the implementation, such as when a single image or a stereo pair of images may be obtained. The data capture operation 402 may also optionally include a depth data capture function 406, which could be used to obtain depth maps or other depth data associated with the one or more images. If the depth data capture function 406 is used, the depth data may be obtained from any suitable source, such as from one or more depth sensors 180 (like one or more LIDAR or time-of-flight depth sensors) of the electronic device 101.

An eye region extraction operation 408 generally operates to identify and isolate or extract portions of images containing people's eyes 206. In this example, the eye region extraction operation 408 can include a face detection network 410, which generally operates to process images and identify people's faces in the images. The face detection network 410 can use any suitable technique(s) to identify faces in images. In some cases, the face detection network 410 can represent a machine learning model that has been trained to recognize and isolate or extract people's faces within images, although the face detection network 410 may be implemented in any other suitable manner.

The eye region extraction operation 408 can also include an eyeglasses detection function 412, which generally operates to process images and determine whether people 204 in the images are wearing eyeglasses. The eyeglasses detection function 412 can use any suitable technique(s) to identify eyeglasses in images. In some cases, the eyeglasses detection function 412 can represent a machine learning model that has been trained to recognize eyeglasses in images, although the eyeglasses detection function 412 may be implemented in any other suitable manner. If a person 204 is wearing eyeglasses in one or more images, an eyeglasses removal network 414 may be used to process the one or more images in order to remove the person's eyeglasses. The eyeglasses removal network 414 can use any suitable technique(s) to remove eyeglasses from images. In some cases, the eyeglasses removal network 414 can represent a machine learning model that has been trained to recognize and remove eyeglasses from people's faces within images, although the eyeglasses removal network 414 may be implemented in any other suitable manner. In this way, the eyeglasses removal network 414 can help to ensure that regions of the image(s) in which a person's eyes 206 are located are not covered by eyeglasses.

The eye region extraction operation 408 can further include a facial landmark extraction function 416, which generally operates to process at least portions of images containing people's faces (possibly as modified by the eyeglasses removal network 414) in order to isolate or extract portions of the images containing the people's eyes 206. For example, the facial landmark extraction function 416 may identify a bounding box or other boundary around each of a person's eyes 206 in one or more images. The facial landmark extraction function 416 can use any suitable technique(s) to identify people's eyes in images. In some cases, the facial landmark extraction function 416 can represent a machine learning model that has been trained to recognize and identify different portions of people's faces (including their eyes), although the facial landmark extraction function 416 may be implemented in any other suitable manner.

A reference object processing operation 418 generally operates to identify reference objects 208 contained in images. In this example, the reference object processing operation 418 can include a reference object detection function 420, which generally operates to process images and identify reference objects in the images. The reference object detection function 420 can use any suitable technique(s) to identify reference objects in images. In some cases, the reference object detection function 420 can represent a machine learning model that has been trained to recognize and identify different types of reference objects in images, such as different types of coins, credit/bank cards, or other objects. The reference object detection function 420 can also identify one or more known dimensions of each reference object 208. Since the reference object detection function 420 may be able to identify different types of reference objects 208, the one or more known dimensions for each identified reference object 208 can be based on the specific type of reference object 208 that is identified by the reference object detection function 420.

The reference object processing operation 418 can also include a reference object extraction function 422, which generally operates to isolate or extract portions of images containing identified reference objects 208. For example, the reference object extraction function 422 may identify a bounding box or other boundary around each identified reference object 208. The reference object extraction function 422 can use any suitable technique(s) to isolate or extract reference objects 208 from images. In some cases, the reference object extraction function 422 can represent a machine learning model that has been trained to recognize and identify different types of reference objects 208, although the reference object extraction function 422 may be implemented in any other suitable manner.

In some embodiments, the reference object processing operation 418 may include or have access to a database or other storage containing templates of known reference objects 208. Each known reference object 208 may be associated with one or more known characteristics, such as a known shape and a known size (one or more known dimensions). In these embodiments, the reference object processing operation 418 may perform pattern matching in order to match one of the templates with a reference object 208 in at least one image in order to detect and isolate/extract the region of the image(s) containing the reference object 208. The reference object processing operation 418 can also identify the one or more known dimensions of the reference object 208 for later use.

The architecture 400 may optionally perform depth processing in order to identify depth values that may be used in subsequent operations. In this example, a decision function 424 may determine whether images being processed by the architecture 400 represent single (individual) images or stereo pairs of images. If single images are being processed, a depth computation operation 426 may optionally be used to estimate depths within each of the individual images. In this example, the depth computation operation 426 can include a depth reconstruction function 428 and a depth identification function 430. The depth reconstruction function 428 generally operates to process individual images and estimate depths within the individual images. The depth reconstruction function 428 can use any suitable technique(s) to estimate depths within individual images. In some cases, the depth reconstruction function 428 can represent a machine learning model (such as a deep neural network) that has been trained to estimate depths within images, although the depth reconstruction function 428 may be implemented in any other suitable manner. In some embodiments, the one or more known dimensions of at least one reference object 208 may be used as part of the depth reconstruction. The depth identification function 430 can use the depths as determined by the depth reconstruction function 428 in order to identify depths associated with the person's eyes 206 and the reference object(s) 208 in each individual image.

If stereo pairs of images are being processed, a depth computation operation 432 may optionally be used to estimate depths within each stereo pair of images. In this example, the depth computation operation 432 can include a stereo vision depth calculation function 434 and a depth identification function 436. The stereo vision depth calculation function 434 generally operates to process pairs of images and estimate depths within the pairs of images. The stereo vision depth calculation function 434 can use any suitable technique(s) to estimate depths within pairs of images. In some cases, the stereo vision depth calculation function 434 can represent a machine learning model (such as a deep neural network) that has been trained to estimate depths within stereo pairs of images, although the stereo vision depth calculation function 434 may be implemented in any other suitable manner (such as when the stereo vision depth calculation function 434 uses disparities or triangulation to estimate depths). In some embodiments, the one or more known dimensions of at least one reference object 208 may be used as part of the depth calculation. The depth identification function 436 can use the depths as determined by the depth reconstruction function 428 in order to identify depths associated with the person's eyes 206 and the reference object(s) 208 in each pair of images.

It should be noted here that the decision function 424 and the depth computation operations 426, 432 are optional and may be excluded in various embodiments of the architecture 400. For example, as described below, estimated depths may be used to support functions like interpupillary distance refinement or interpupillary distance estimation verification. However, if those functions are not needed or desired, estimated depths that are used by those functions may not need to be determined. As another example, when the depth data capture function 406 can be used to capture depth data (even sparse depth data), such as from one or more depth sensors 180 or other source(s), the depth data may be used in place of (or possibly in addition to) the estimated depths identified using the depth computation operation 426 or 432.

As shown in FIG. 4B, a pupil identification operation 438 generally operates to process images and isolate or extract portions of images containing the pupils of people's eyes 206. In this example, the pupil identification operation 438 can include an eye region segmentation function 440, which generally operates to identify the pupils of people's eyes 206 in the images. For example, the eye region segmentation function 440 may perform image segmentation in order to differentiate parts of images containing the pupils of the people's eyes 206 from other parts of the images containing other portions of the people's eyes 206 (like their irises). The eye region segmentation function 440 can use any suitable technique(s) to identify the pupils of people's eyes 206 in images. In some cases, the eye region segmentation function 440 can represent a machine learning model (such as a fully convolutional network) that has been trained to recognize and isolate or extract the pupils of people's eyes 206 within images, although the eye region segmentation function 440 may be implemented in any other suitable manner.

The pupil identification operation 438 can also include a pupil center extraction function 442, which generally operates to identify and isolate or extract portions of images containing the centers of the identified pupils (such as by identifying the centers of a person's left and right pupils in an image). The pupil center extraction function 442 can use any suitable technique(s) to identify the centers of the pupils of people's eyes 206 in images. In some cases, the pupil center extraction function 442 may treat each identified pupil as circular, identify the center of each circle, and use the center of each circle as the center of the associated pupil.

A sizing factor identification operation 444 generally operates to process images and identify sizing factors (scaling factors) associated with reference objects in the images. In this example, the sizing factor identification operation 444 can include a reference object size processing function 446, which generally operates to identify one or more known dimensions of each reference object 208 captured in one or more images. In some cases, the reference object size processing function 446 may identify one or more known dimensions of each reference object 208, such as by using a database or other storage containing dimensions of known reference objects. Note that this function may be optional since (as described above) the size of each reference object 208 could be determined by the reference object processing operation 418.

The sizing factor identification operation 444 can also include a reference object projection function 448, which generally operates to project images (or portions of images) capturing reference objects 208 onto corresponding planes associated with people's eyes 206 in those images. This may be necessary or desirable since it may often be the case that a reference object 208 captured in one or more images will be positioned on a different plane than a person's eyes 206 captured in the same image(s). For example, a plane of a reference object 208 may be translated (such as when positioned ahead of or behind) a plane on which a person's eyes 206 are located. Also or alternatively, the plane of a reference object 208 may be rotated relative to the plane on which a person's eyes 206 are located.

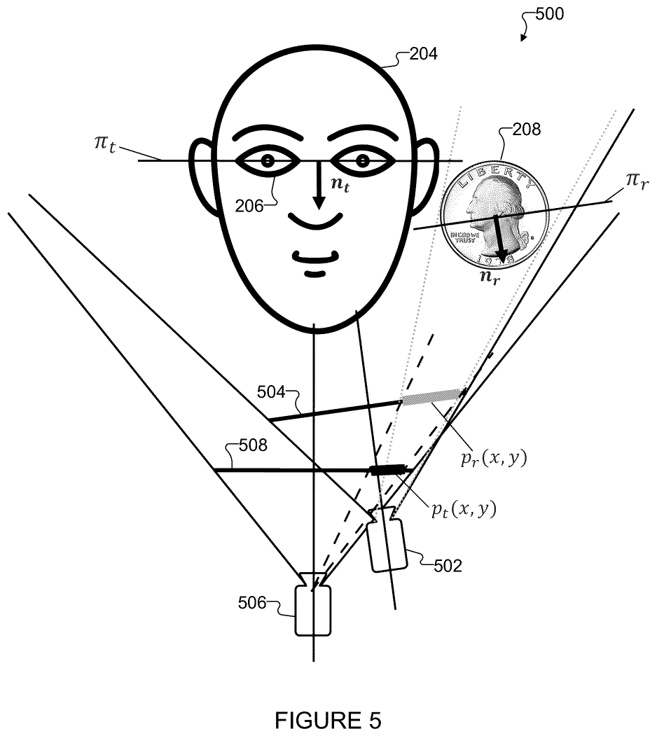

The reference object projection function 448 can therefore be used to warp or otherwise transform image data capturing a reference object 208 in each of one or more images from a plane of the reference object 208 onto a plane associated with image data capturing a person's eyes 206 in that image. The transformation applied here can be used to provide translation, rotation, or both so that the warped image data capturing the reference object 208 in each image resides on the same plane as the image data capturing the person's eyes 206 in that image. The reference object projection function 448 may use any suitable technique(s) to warp image data. One example technique that could be used by the reference object projection function 448 is described below with reference to FIG. 5.

The sizing factor identification operation 444 can further include a sizing factor identification function 450, which generally operates to estimate sizing factors for reference objects 208 captured in images. For example, the sizing factor identification function 450 may count pixels associated with each reference object 208 as projected by the reference object projection function 448. As particular examples, the sizing factor identification function 450 may count the number of pixels of image data occupied by each reference object 208 horizontally, vertically, diagonally, or in any other suitable direction(s). The sizing factor identification operation 444 can also divide one or more known dimensions of each reference object 208 by one or more pixel counts for that reference object 208, such as by dividing a known horizontal dimension of each reference object 208 by the number of pixels of image data occupied by the reference object 208 horizontally or by dividing a known vertical dimension of each reference object 208 by the number of pixels of image data occupied by the reference object 208 vertically. This results in the generation of a sizing factor for each reference object 208, where the sizing factor identifies a distance associated with each pixel of image data for that reference object 208.

In addition, the sizing factor identification operation 444 can optionally include a sizing factor refinement function 452, which could generally operate to verify or refine each sizing factor determined by the sizing factor identification operation 444. In some cases, sizing factors can be verified or refined using depths within the images being processed. As noted above, the depths within a scene may represent actual depth measurements or estimates of depths generated using one or more images of the scene. In some cases, the sizing factor refinement function 452 may use the actual or estimated depths within a scene (such as actual or estimated depths at pupils of a person's eyes 206) to verify whether a sizing factor determined for that scene appears accurate. The verification may occur in any suitable manner, such as by performing triangulation and verifying whether distances estimated via the triangulation appear consistent with distances determined using the sizing factor.

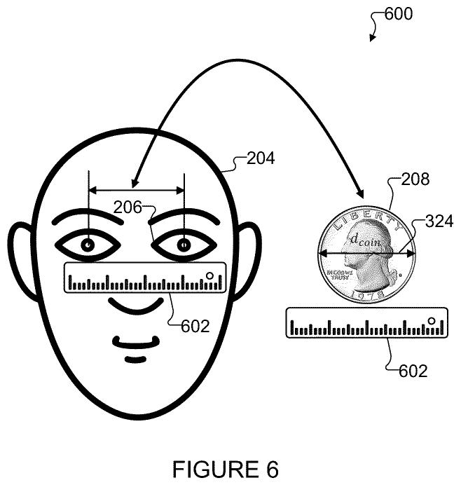

A sizing factor determined for each image or each stereo pair of images can be used to estimate the interpupillary distance of a person captured in the image(s). In this example, a decision function 454 may determine whether images being processed by the architecture 400 represent single (individual) images or stereo pairs of images. If single images are being processed, a single-view IPD calculation operation 456 can be performed. The single-view IPD calculation operation 456 generally operates to estimate the interpupillary distance of a person within each of one or more individual images based on (among other things) the sizing factor for each individual image. In this example, the single-view IPD calculation operation 456 can include an IPD computation function 458 and an optional IPD refinement function 460. The IPD computation function 458 generally operates to estimate the interpupillary distance of a person for each of one or more images. For example, the IPD computation function 458 may count the number of pixels between the centers of the person's pupils in each image (as determined by the pupil identification operation 438) and multiply the number of pixels by the sizing factor (as determined by the sizing factor identification operation 444). One example technique that could be used by the IPD computation function 458 is described below with reference to FIG. 6.

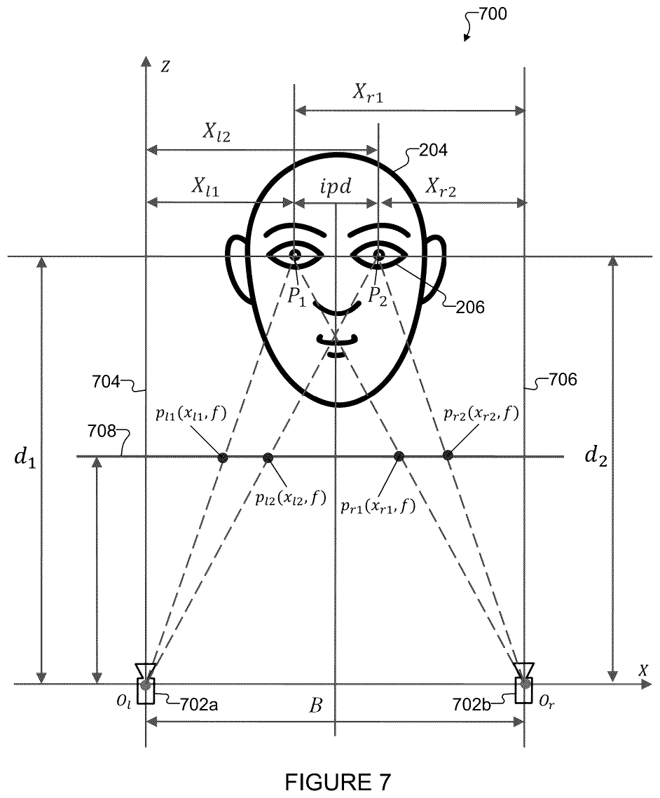

The IPD refinement function 460 may optionally be used to refine or verify one or more interpupillary distances as determined by the IPD computation function 458. For example, the IPD refinement function 460 can use actual or estimated depths with each scene (such as actual or estimated depths at the pupils of the person's eyes 206) in order to refine or verify the interpupillary distance of the person captured in one or more images of that scene. One example technique that could be used by the IPD refinement function 460 is described below with reference to FIG. 7.

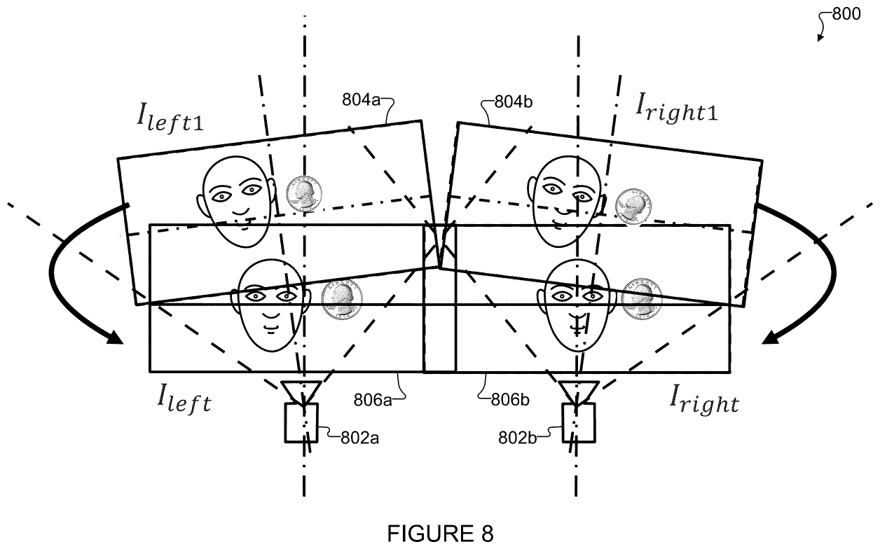

If stereo pairs of images are being processed, a stereo-view IPD calculation operation 462 can be used. The stereo-view IPD calculation operation 462 generally operates to estimate the interpupillary distance of a person within one or more stereo pairs of images based on (among other things) the sizing factor for each stereo pair of images. In this example, the stereo-view IPD calculation operation 462 can include an image rectification and IPD computation function 464 and an optional IPD refinement function 466. The image rectification and IPD computation function 464 generally operates to rectify (align) images in each stereo pair of images and estimate the interpupillary distance of a person for each pair of aligned images. For example, the IPD computation function 464 may count the number of pixels between the centers of the person's pupils in each pair of images (as determined by the pupil identification operation 438) and multiply the number of pixels by the sizing factor (as determined by the sizing factor identification operation 444). One example technique that could be used by the image rectification and IPD computation function 464 to perform image rectification is described below with reference to FIG. 8. The image rectification and IPD computation function 464 may also use the same or similar technique described below with reference to FIG. 6 to calculate an interpupillary distance estimate.

The IPD refinement function 466 may optionally be used to refine or verify one or more interpupillary distances as determined by the image rectification and IPD computation function 464. For example, the IPD refinement function 466 can use actual or estimated depths with each scene (such as actual or estimated depths at the pupils of the person's eyes 206) in order to refine or verify the interpupillary distance of the person captured in one or more stereo pair of images of that scene. The IPD refinement function 466 may use the technique described below with reference to FIG. 7.

One or more interpupillary distance estimates generated by the architecture 400 may be provided to an IPD application/output operation 468, which generally operates to store, output, or use the interpupillary distance estimate(s) in some manner. For example, an IPD output function 470 may be used to output an interpupillary distance estimate, such as by displaying the interpupillary distance estimate or by providing the interpupillary distance estimate to an external device or system (such as an XR headset). An IPD pipeline application function 472 may be used to provide an interpupillary distance estimate to an image processing pipeline or other processing pipeline for use. As a particular example, the IPD pipeline application function 472 may provide an interpupillary distance estimate to an XR pipeline for use in generating rendered images for presentation to a user of an XR headset. Note, however, that interpupillary distance estimates generated by the architecture 400 may be used in any other suitable manner.

In this way, the architecture 400 supports the estimation of a person's interpupillary distance based on (i) the number of pixels between the centers of the person's eyes in one or more images and (ii) a reference object with one or more known dimensions in the image(s). Various pre-processing operations can be performed, such as for identifying pupil centers. Various post-processing operations can also or alternatively be performed, such as for verifying the interpupillary distance estimate.

Although FIGS. 4A and 4B illustrate one example of an architecture 400 supporting adaptive interpupillary distance estimation, various changes may be made to FIGS. 4A and 4B. For example, various components, operations, or functions in FIGS. 4A and 4B may be combined, further subdivided, replicated, omitted, or rearranged and additional components, operations, or functions may be added according to particular needs. As a particular example, the identification of the planes on which a person's eyes 206 are located and on which a reference object 208 is located may be performed using a deep neural network or other machine learning model (which may or may not represent one of the deep neural networks or other machine learning models described above as being used to perform another function in the architecture 400). Using these identified planes, the projection of the reference object 208 from its plane to the plane of the person's eyes 206 may occur as described above. In these cases, there may be little or no need to perform verification of interpupillary distance estimates based on depths (although this may still occur if needed or desired).

FIG. 5 illustrates an example process 500 for planar reprojection associated with a reference object 208 during adaptive interpupillary distance estimation in accordance with this disclosure. In some embodiments, the process 500 may be performed as part of the interpupillary distance estimation operation 300 shown in FIG. 3 or the reference object projection function 448 shown in FIG. 4B. For case of explanation, the process 500 shown in FIG. 5 is described as being performed using or as involving the use of the electronic device 101 in the network configuration 100 shown in FIG. 1. However, the process 500 may be performed using any other suitable device(s) and in any other suitable system(s).

As shown in FIG. 5, when an image is captured of a person 204 and a reference object 208, the reference object 208 may not be coplanar with the person's eyes 206. That is, the person 204 is shown here as having his or her eyes 206 located on a plane πₜ having a normal vector nₜ, while the reference object 208 is shown here as being located on a plane πᵣ having a normal vector nᵣ. In order to use the reference object 208 to estimate the interpupillary distance of the person's eyes 206, the reference object 208 is projected from the plane πᵣ onto the plane πₜ. In this example, a camera 502 represents a reference camera, which could be used to capture an image 504 of the person 204 and the reference object 208. A portion pᵣ(x, y) of the image 504 may indicate the size of the reference object 208 as captured in the image 504. One goal of the projection here can be to project the image 504 so that the resulting projection appears to have been captured by a target camera 506 as an image 508. A portion pₜ(x, y) of the image 508 can indicate the size of the reference object 208 as captured in the image 508.

In some cases, this projection may be performed as follows. Assume that the plane πₜ has a projection matrix Pₜ=[I|0] and that the plane πᵣ has a projection matrix Pᵣ=[R|t]. Based on this, it is possible to project the plane πᵣ to the plane πₜ in the following manner:

$${p}_{t} ( x , y ) = H {p}_{r} ( x , y )$$

$$where :$$

$$H = R - t \frac{{n}_{r}}{{d}_{r}}$$

Here, R represents the rotation and t represents the translation between the two planes. Also, pᵣ(x, y) represents pixels of image data prior to projection, and pₜ(x, y) represents pixels of image data after projection. In addition, dᵣ represents the distance between the reference camera 502 and the plane πᵣ. By projecting the plane πᵣ onto the plane πₜ, it is possible to set the same reference for both the eye plane πₜ and the reference object plane πᵣ.

FIG. 6 illustrates an example process 600 for identification of pixels during adaptive interpupillary distance estimation in accordance with this disclosure. In some embodiments, the process 600 may be performed as part of the interpupillary distance estimation operation 300 shown in FIG. 3 or the IPD computation function 458 or the image rectification and IPD computation function 464 shown in FIG. 4B. For case of explanation, the process 600 shown in FIG. 6 is described as being performed using or as involving the use of the electronic device 101 in the network configuration 100 shown in FIG. 1. However, the process 600 may be performed using any other suitable device(s) and in any other suitable system(s).

As shown in FIG. 6, once a reference object 208 is projected onto the same plane as the person's eyes 206, both the reference object 208 and the person's eyes 206 can have the same scale 602. As a result, it becomes possible to use one or more known dimensions 324 of the reference object 208 to estimate the interpupillary distance of the person's eyes 206. For example, assume that the dimension 324 of the reference object 208 is denoted d_{ref} and has a known value. The number of pixels along that dimension 324 of the reference object 208 can be counted and denoted n_{ref}. From this, a sizing factor s can be calculated as follows.

$$s = \frac{{d}_{r e f}}{{n}_{r e f}}$$

This gives a distance for each pixel of the reference object 208 along the known dimension 324 of the reference object 208. The number of pixels between the centers of the person's pupils can be counted and denoted n_{ipd}. An estimate of the person's interpupillary distance can be denoted ipdₘₑₐₛᵤᵣₑ and can be calculated as follows.

$$i p {d}_{m e a s u r e} = s {n}_{ipd}$$

Again, it should be noted that any suitable reference object 208 may be used here. As long as the reference object 208 has one or more known dimensions, it is possible to count the number of pixels occupied by the reference object 208 along the known dimension(s) after projection and to use the pixel count(s) and the known dimension(s) to estimate the person's interpupillary distance.

FIG. 7 illustrates an example process 700 for verification of an interpupillary distance estimation during adaptive interpupillary distance estimation in accordance with this disclosure. In some embodiments, the process 700 may be performed as part of the interpupillary distance refinement operation 320 shown in FIG. 3 or the IPD refinement function 460 or the IPD refinement function 466 shown in FIG. 4B. For case of explanation, the process 700 shown in FIG. 7 is described as being performed using or as involving the use of the electronic device 101 in the network configuration 100 shown in FIG. 1. However, the process 700 may be performed using any other suitable device(s) and in any other suitable system(s).

As shown in FIG. 7, the locations of the centers of the person's pupils are represented as points P₁ and P₂. The person's pupil at point P₁ has a depth d₁ from a camera 702a, where the camera 702a has an image plane with an origin Oₗ. Similarly, the person's pupil at point P₂ has a depth d₂ from a camera 702b, where the camera 702b has an image plane with an origin Oᵣ. In some cases, it may be assumed that the depths d₁ and d₂ are equal, although this need not be the case. The cameras 702a-702b are separated by a known baseline distance B. The camera 702a has an optical axis 704, and the camera 702b has an optical axis 706. Based on this, distances Xₗ₁ and Xₗ₂ are defined between the axis 704 and the points P₁ and P₂, respectively. Also, distances Xᵣ₁ and Xᵣ₂ are defined between the axis 706 and the points P₁ and P₂, respectively. The cameras 702a-702b are assumed here to be able to capture images at a common image plane 708, meaning they have a common focal length (although this need not be the case).

In this example, the point P₁ when viewed by the camera 702a appears at a point pₗ₁(xₗ₁, f) within an image captured by the camera 702a, and the point P₂ when viewed by the camera 702a appears at a point pₗ₂(xₗ₂, f) within the image captured by the camera 702a. Similarly, the point P₁ when viewed by the camera 702b appears at a point pᵣ₁(xᵣ₁, f) within an image captured by the camera 702b, and the point P₂ when viewed by the camera 702b appears at a point pᵣ₂(xᵣ₂, f) within the image captured by the camera 702b. Here, f denotes the focal lengths of the cameras 702a-702b, which again are assumed to be equal here (although this need not be the case).

Given this, for the camera 702a, the following can be obtained.

$$\{ \begin{matrix}{X}_{l 1} = \frac{{d}_{1}}{f} {x}_{l 1} \\ {X}_{l 2} = \frac{{d}_{1}}{f} {x}_{l 2}\end{matrix}$$

For the camera 702b, the following can be obtained.

$$\{ \begin{matrix}{X}_{r 1} = \frac{{d}_{2}}{f} {x}_{r 1} \\ {X}_{r 2} = \frac{{d}_{r}}{f} {x}_{r 2}\end{matrix}$$

These equations allow the electronic device 101 or another device to identify the locations of the centers of the pupils of the person's eyes 206 in a three-dimensional (3D) space. These locations are based on (i) the distances (d₁ and d₂) between at least one camera and the centers of the pupils of the person's eyes 206, (ii) a focal length of each camera, and (iii) locations of the centers of the pupils of the person's eyes 206 in the image(s) being processed. From these, estimates of the person's interpupillary distance can be determined as follows.

$$\begin{matrix}ip {d}_{est\_left} = {X}_{l 2} - {X}_{l 1} \\ {ipd}_{est\_right} = {X}_{r 1} - {X}_{r 2} \\ ip {d}_{est\_left \_right} = B - {X}_{l 1} - {X}_{r 2}\end{matrix}$$

Here, ipd_{est_left} and ipd_{est_right} represent estimates of the person's interpupillary distance based on the image(s) from the cameras 702a-702b, respectively, and ipd_{est_left_right} represents a final estimate of the person's interpupillary distance. It is therefore possible to verify or refine an interpupillary distance estimate (such as ipdₘₑₐₛᵤᵣₑ) by comparison with the final estimate ipd_{est_left_right}. Note that while two cameras 702a-702b are shown here, it is possible to derive similar equations used for validation with a single camera.

FIG. 8 illustrates an example process 800 for rectification of a stereo pair of images during adaptive interpupillary distance estimation in accordance with this disclosure. In some embodiments, the process 800 may be performed as part of the image rectification operation 340 shown in FIG. 3 or the image rectification and IPD computation function 464 shown in FIG. 4B. For case of explanation, the process 800 shown in FIG. 8 is described as being performed using or as involving the use of the electronic device 101 in the network configuration 100 shown in FIG. 1. However, the process 800 may be performed using any other suitable device(s) and in any other suitable system(s).

As shown in FIG. 8, two cameras 802a-802b can be used to capture a stereo pair of images 804a-804b. Although exaggerated here for case of illustration and explanation, the different cameras 802a-802b have different viewpoints relative to the same scene being imaged, so the images 804a-804b will capture the scene in somewhat different ways. In some cases, this can also be due to the fact that the cameras 802a-802b may not be precisely parallel to one another. As a particular example, in some embodiments, the cameras 802a-802b may point inward or outward relative to one another.

In this example, the captured images 804a-804b are respectively denoted l_{left1} and I_{right1}. The captured images 804a-804b in the pair can be rectified using camera calibration to create a rectified pair of images 806a-806b, which are respectively denoted I_{left} and I_{right}. In some cases, this rectification can be defined as follows.

$$\{ \begin{matrix}{I}_{left} = ℛ ( {I}_{left 1} ) \\ {I}_{right} = ℛ ( {I}_{right 1} )\end{matrix}$$

Here, [symbol] represents a transformation based on the camera calibration. The transformation [symbol] can be derived based on the properties of the cameras 802a-802b, such as the known aiming direction(s) of the cameras 802a-802b and the positions of the cameras 802a-802b (such as relative to each other). After rectification is performed, the centers of the person's pupils in the rectified images 806a-806b can be identified, and depths to the centers of the person's pupils can be identified and used to verify at least one previous interpupillary distance estimate (such as in the same or similar manner as that shown in FIG. 7).

Although FIGS. 5 through 8 illustrate examples of processes during adaptive interpupillary distance estimation, various changes may be made to FIGS. 5 through 8. For example, while FIGS. 5 through 8 illustrate specific example techniques for performing planar reprojection, pixel identification, interpupillary distance estimation verification, and rectification, each of these functions may be performed using any other suitable techniques.

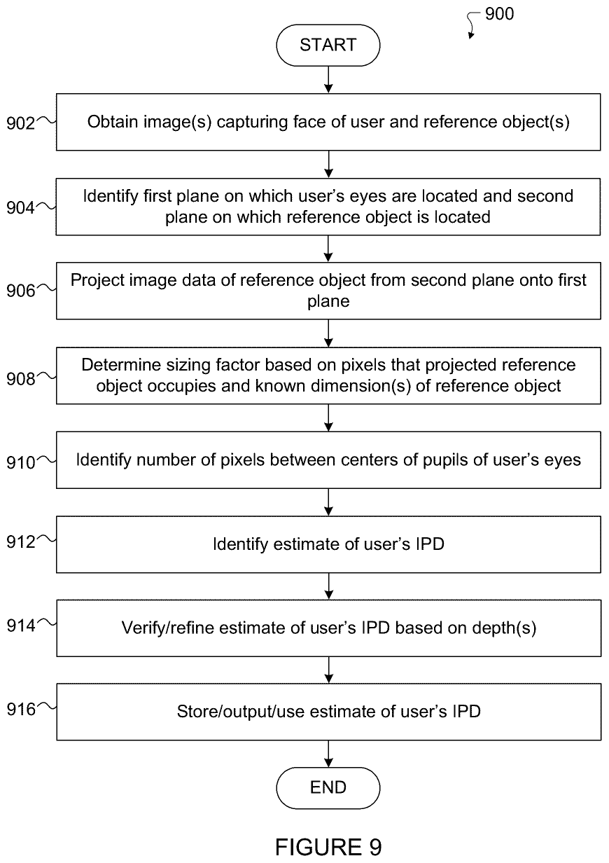

FIG. 9 illustrates an example method 900 for adaptive interpupillary distance estimation in accordance with this disclosure. For case of explanation, the method 900 shown in FIG. 9 is described as being performed using or as involving the use of the electronic device 101 in the network configuration 100 shown in FIG. 1. However, the method 900 may be performed using any other suitable device(s) and in any other suitable system(s).

As shown in FIG. 9, one or more images capturing a face of a user and a reference object with one or more known dimensions are obtained at step 902. This may include, for example, the processor 120 of the electronic device 101 obtaining one or more images captured using one or more cameras or other imaging sensors 180. The one or more images can capture a person's face and eyes 206, along with at least one reference object 208. Each reference object 208 has one or more known dimensions, such as a known width, height, or diameter. In some cases, the reference object 208 can represent any object having a known size, and the reference object 208 may be positioned at any location within the one or more images where the reference object 208 is fully visible and the person's eyes 206 are not blocked.

A first plane on which the eyes of the user are located and a second plane on which the reference object is located are identified at step 904. This may include, for example, the processor 120 of the electronic device 101 processing the one or more images to estimate a plane passing through the person's eyes 206 and a plane passing through the reference object 208. In some cases, this may be performed using a trained machine learning model. Image data of the reference object is projected from the second plane onto the first plane at step 906. This may include, for example, the processor 120 of the electronic device 101 performing a projection to apply a translation and/or a rotation to the image data of the reference object 208. This results in image data for the person's eyes 206 and the image data for the reference object 208 having the same scale.

A sizing factor is determined based on (i) pixels that the reference object occupies after being projected onto the first plane and (ii) the one or more known dimensions of the reference object at step 908. This may include, for example, the processor 120 of the electronic device 101 counting the number of pixels of image data of the reference object 208 along each known dimension of the reference object 208. This may also include the processor 120 of the electronic device 101 dividing the known dimension by the counted number of pixels for that known dimension. This provides a measure of distance represented by each pixel of the image data of the reference object 208 along the known dimension.

A number of pixels between centers of pupils of the user's eyes in the one or more images is identified at step 910. This may include, for example, the processor 120 of the electronic device 101 counting the number of pixels of image data between the centers of the pupils in the person's eyes 206 in each image. In some cases, a face detection model (such as the face detection network 410) may be used to identify an area in each of the one or more images containing the user's face, and a facial landmark extraction model (such as the facial landmark extraction function 416) may be used to identify the centers of the pupils of the user's eyes 206 in each area containing the user's face. This may also optionally include removing eyeglasses worn by the person in the image(s) (if present). An estimate of an interpupillary distance of the user's eyes is identified at step 912. This may include, for example, the processor 120 of the electronic device 101 applying the sizing factor to the number of pixels between the centers of the pupils of the user's eyes 206. As a particular example, this may include the processor 120 of the electronic device 101 multiplying the counted number of pixels of image data between the centers of the pupils in the person's eyes 206 by the sizing factor.

The estimate of the user's interpupillary distance may optionally be verified or refined at step 914. This may include, for example, the processor 120 of the electronic device 101 using estimated or measured depths within the one or more images to validate the estimate of the person's interpupillary distance. In some embodiments, this may involve identifying distances between the imaging sensor(s) used to capture the image(s) and the centers of the pupils of the person's eyes 206 based on depth data associated with the image(s) and identifying locations of the centers of the pupils of the person's eyes 206 in 3D space. The locations of the centers of the person's pupils can be based on (i) the distances between the imaging sensor(s) and the centers of the person's pupils, (ii) a focal length of each imaging sensor, and (iii) locations of the centers of the person's pupils in the image(s). From this, a second estimate of the interpupillary distance of the person's eyes can be identified based on a difference in the locations of the centers of the person's pupils in the 3D space, and the estimates can be compared. In other embodiments, this may involve rectifying a stereo pair of images to generate a rectified stereo pair of images, identifying distances between the imaging sensor(s) used to capture the stereo pair of images and the centers of the person's pupils based on the rectified stereo pair of images, and verifying the interpupillary distance estimate based on the distances between the imaging sensor(s) and the centers of the person's pupils.

The estimate of the user's interpupillary distance can be stored, output, or used in some manner at step 916. There are a number of ways in which the estimate of the person's interpupillary distance might be used depending on the application. In some cases, for example, the estimate of the person's interpupillary distance could be displayed on the electronic device 101. The estimate of the person's interpupillary distance may be provided to another device for use, such as when the electronic device 101 represents a smartphone or other device and the estimate of the person's interpupillary distance is provided to an XR headset or other system for use. The estimate of the person's interpupillary distance may be used by the electronic device 101 itself to perform one or more functions, such as when the electronic device 101 can use the estimate of the person's interpupillary distance to perform XR-related or other image-related processing tasks. In general, this disclosure is not limited to any particular use of estimates of people's interpupillary distances.

Although FIG. 9 illustrates one example of a method 900 for adaptive interpupillary distance estimation, various changes may be made to FIG. 9. For example, while shown as a series of steps, various steps in FIG. 9 may overlap, occur in parallel, occur in a different order, or occur any number of times (including zero times).

It should be noted that the functions shown in or described with respect to FIGS. 2 through 9 can be implemented in an electronic device 101, 102, 104, server 106, or other device(s) in any suitable manner. For example, in some embodiments, at least some of the functions shown in or described with respect to FIGS. 2 through 9 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 9 can be implemented or supported using dedicated hardware components. In general, the functions shown in or described with respect to FIGS. 2 through 9 can be performed using any suitable hardware or any suitable combination of hardware and software/firmware instructions. Also, the functions shown in or described with respect to FIGS. 2 through 9 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, one or more images capturing a face of a user and a reference object with one or more known dimensions;
identifying, using the at least one processing device, a first plane on which eyes of the user are located and a second plane on which the reference object is located;
projecting, using the at least one processing device, image data of the reference object from the second plane onto the first plane;
determining, using the at least one processing device, a sizing factor based on (i) pixels that the reference object occupies after being projected onto the first plane and (ii) the one or more known dimensions;
identifying, using the at least one processing device, a number of pixels between centers of pupils of the user's eyes in the one or more images; and
identifying, using the at least one processing device, a first estimate of an interpupillary distance of the user's eyes by applying the sizing factor to the number of pixels between the centers of the pupils of the user's eyes.

2. The method of claim 1, wherein determining the number of pixels between the centers of the pupils of the user's eyes comprises:
using a face detection model to identify an area in each of the one or more images containing the user's face; and
using a facial landmark extraction model to identify the centers of the pupils of the user's eyes in each area containing the user's face.

3. The method of claim 1, further comprising:
verifying the first estimate of the interpupillary distance of the user's eyes by:
identifying distances between at least one imaging sensor used to capture the one or more images and the centers of the pupils of the user's eyes based on depth data associated with the one or more images;
identifying locations of the centers of the pupils of the user's eyes in a three-dimensional (3D) space based on (i) the distances between the at least one imaging sensor and the centers of the pupils of the user's eyes, (ii) a focal length of each imaging sensor, and (iii) locations of the centers of the pupils of the user's eyes in the one or more images;
identifying a second estimate of the interpupillary distance of the user's eyes based on a difference in the locations of the centers of the pupils of the user's eyes in the 3D space; and
comparing the second estimate of the interpupillary distance of the user's eyes to the first estimate of the interpupillary distance of the user's eyes.

4. The method of claim 1, wherein:
the one or more images comprise a stereo pair of images; and
the method further comprises verifying the first estimate of the interpupillary distance of the user's eyes by:
rectifying the stereo pair of images to generate a rectified stereo pair of images;
identifying distances between at least one imaging sensor used to capture the stereo pair of images and the centers of the pupils of the user's eyes based on the rectified stereo pair of images; and
verifying the first estimate of the interpupillary distance of the user's eyes based on the distances between the at least one imaging sensor and the centers of the pupils of the user's eyes.

5. The method of claim 1, wherein identifying the first and second planes comprises identifying the first and second planes using a trained machine learning model.

6. The method of claim 1, wherein:
the electronic device comprises a portable computing device; and
the method further comprises transmitting the first estimate of the interpupillary distance of the user's eyes to an extended reality (XR) headset configured to be worn by the user.

7. The method of claim 1, wherein:
the reference object comprises any object having a known size; and
the reference object is positioned at any location within the one or more images where the reference object is fully visible.

8. An electronic device comprising:
at least one processing device configured to:
obtain one or more images capturing a face of a user and a reference object with one or more known dimensions;
identify a first plane on which eyes of the user are located and a second plane on which the reference object is located;
project image data of the reference object from the second plane onto the first plane;
determine a sizing factor based on (i) pixels that the reference object occupies after being projected onto the first plane and (ii) the one or more known dimensions;
identify a number of pixels between centers of pupils of the user's eyes in the one or more images; and
identify a first estimate of an interpupillary distance of the user's eyes by applying the sizing factor to the number of pixels between the centers of the pupils of the user's eyes.

9. The electronic device of claim 8, wherein, to determine the number of pixels between the centers of the pupils of the user's eyes, the at least one processing device is configured to:
use a face detection model to identify an area in each of the one or more images containing the user's face; and
use a facial landmark extraction model to identify the centers of the pupils of the user's eyes in each area containing the user's face.

10. The electronic device of claim 8, wherein:
the at least one processing device is further configured to verify the first estimate of the interpupillary distance of the user's eyes; and
to verify the first estimate of the interpupillary distance of the user's eyes, the at least one processing device is configured to:
identify distances between at least one imaging sensor used to capture the one or more images and the centers of the pupils of the user's eyes based on depth data associated with the one or more images;
identify locations of the centers of the pupils of the user's eyes in a three-dimensional (3D) space based on (i) the distances between the at least one imaging sensor and the centers of the pupils of the user's eyes, (ii) a focal length of each imaging sensor, and (iii) locations of the centers of the pupils of the user's eyes in the one or more images;
identify a second estimate of the interpupillary distance of the user's eyes based on a difference in the locations of the centers of the pupils of the user's eyes in the 3D space; and
compare the second estimate of the interpupillary distance of the user's eyes to the first estimate of the interpupillary distance of the user's eyes.

11. The electronic device of claim 8, wherein:
the one or more images comprise a stereo pair of images;
the at least one processing device is further configured to verify the first estimate of the interpupillary distance of the user's eyes; and
to verify the first estimate of the interpupillary distance of the user's eyes, the at least one processing device is configured to:
rectify the stereo pair of images to generate a rectified stereo pair of images;
identify distances between at least one imaging sensor used to capture the stereo pair of images and the centers of the pupils of the user's eyes based on the rectified stereo pair of images; and
verify the first estimate of the interpupillary distance of the user's eyes based on the distances between the at least one imaging sensor and the centers of the pupils of the user's eyes.

12. The electronic device of claim 8, wherein the at least one processing device is configured to identify the first and second planes using a trained machine learning model.

13. The electronic device of claim 8, wherein:
the electronic device represents a portable computing device; and
the at least one processing device is configured to initiate transmission of the first estimate of the interpupillary distance of the user's eyes to an extended reality (XR) headset configured to be worn by the user.

14. The electronic device of claim 8, wherein:
the reference object comprises any object having a known size; and
the reference object is positioned at any location within the one or more images where the reference object is fully visible.

15. A non-transitory machine readable medium containing instructions that when executed cause at least one processor of an electronic device to:
obtain one or more images capturing a face of a user and a reference object with one or more known dimensions;
identify a first plane on which eyes of the user are located and a second plane on which the reference object is located;
project image data of the reference object from the second plane onto the first plane;
determine a sizing factor based on (i) pixels that the reference object occupies after being projected onto the first plane and (ii) the one or more known dimensions;
identify a number of pixels between centers of pupils of the user's eyes in the one or more images; and
identify a first estimate of an interpupillary distance of the user's eyes by applying the sizing factor to the number of pixels between the centers of the pupils of the user's eyes.

16. The non-transitory machine readable medium of claim 15, wherein the instructions that when executed cause the at least one processor to determine the number of pixels between the centers of the pupils of the user's eyes comprise:
instructions that when executed cause the at least one processor to:
use a face detection model to identify an area in each of the one or more images containing the user's face; and
use a facial landmark extraction model to identify the centers of the pupils of the user's eyes in each area containing the user's face.

17. The non-transitory machine readable medium of claim 15, wherein:
the non-transitory machine readable medium further contains instructions that when executed cause the at least one processor to verify the first estimate of the interpupillary distance of the user's eyes; and
the instructions that when executed cause the at least one processor to verify the first estimate of the interpupillary distance of the user's eyes comprise instructions that when executed cause the at least one processor to:
identify distances between at least one imaging sensor used to capture the one or more images and the centers of the pupils of the user's eyes based on depth data associated with the one or more images;
identify locations of the centers of the pupils of the user's eyes in a three-dimensional (3D) space based on (i) the distances between the at least one imaging sensor and the centers of the pupils of the user's eyes, (ii) a focal length of each imaging sensor, and (iii) locations of the centers of the pupils of the user's eyes in the one or more images;
identify a second estimate of the interpupillary distance of the user's eyes based on a difference in the locations of the centers of the pupils of the user's eyes in the 3D space; and
compare the second estimate of the interpupillary distance of the user's eyes to the first estimate of the interpupillary distance of the user's eyes.

18. The non-transitory machine readable medium of claim 15, wherein:
the one or more images comprise a stereo pair of images;
the non-transitory machine readable medium further contains instructions that when executed cause the at least one processor to verify the first estimate of the interpupillary distance of the user's eyes; and
the instructions that when executed cause the at least one processor to verify the first estimate of the interpupillary distance of the user's eyes comprise instructions that when executed cause the at least one processor to:
rectify the stereo pair of images to generate a rectified stereo pair of images;
identify distances between at least one imaging sensor used to capture the stereo pair of images and the centers of the pupils of the user's eyes based on the rectified stereo pair of images; and
verify the first estimate of the interpupillary distance of the user's eyes based on the distances between the at least one imaging sensor and the centers of the pupils of the user's eyes.

19. The non-transitory machine readable medium of claim 15, wherein the instructions when executed cause the at least one processor to identify the first and second planes using a trained machine learning model.

20. The non-transitory machine readable medium of claim 15, wherein the non-transitory machine readable medium further contains instructions that when executed cause the at least one processor to initiate transmission of the first estimate of the interpupillary distance of the user's eyes to an extended reality (XR) headset configured to be worn by the user.
